(19) United States
(12) Patent Application Publication
(10) Pub. No.: US 2018/0162051 A1
(43) Pub. Date: Jun. 14, 2018

(54) ADDITIVE MANUFACTURING ARRANGEMENT WITH SHARED RADIATION SOURCE

(71) Applicant: AddiFab ApS, Jyllinge (DK)

(72) Inventor: Jon JESSEN, Veksø (DK)

(21) Appl. No.: 15/574,925

(22) PCT Filed: May 18, 2016
(86) PCT No.: PCT/EP2016/061090

§ 371 Date: Nov. 17, 2017

(30) Foreign Application Priority Data
May 19, 2015 (DK) PA201570292

(51) Int. Cl. B29C 64/264; B29C 64/135; B29C 64/255; B33Y 10/00; B33Y 30/00

(52) U.S. Cl. CPC B29C 64/264; B29C 64/135; B33Y 30/00; B33Y 10/00; B29C 64/255

(57) ABSTRACT

The present invention provides an additive manufacturing arrangement comprising at least a first and a second additive manufacturing apparatus, each additive manufacturing apparatus comprising: a container for holding a radiation-curable liquid, a build platform having a build surface for holding a product to be manufactured during a manufacturing process, the build platform being movable relative to the container in a predetermined direction, a local radiation source configured to provide hardening radiation for selectively hardening radiation-curable liquid in the container to form the product; and the arrangement is characterized in that the arrangement comprises a first central radiation source configured to provide hardening radiation for selectively hardening radiation-curable liquid in the first and second container of the respective first and second additive manufacturing apparatus, and each local radiation source comprises a radiation input configured to receive hardening radiation from the first central radiation source and to emit at least part of said hardening radiation to selectively harden radiation-curable liquid in the corresponding container, and there is a first radiation splitter for splitting radiation from the first central radiation source into at least a first part and a second part, wherein the additive manufacturing arrangement is arranged to provide the first part to the radiation input of the first additive manufacturing apparatus and arranged to provide the second part to the radiation input of the second additive manufacturing apparatus.

### TECHNICAL FIELD

The present invention relates to additive manufacturing.

### BACKGROUND OF THE INVENTION

Additive manufacturing has gained solid acceptance as a tool for prototyping and production of unique/custom-fit products (hearing aids, jewelry, dental implants). For those applications, there is little need for repeatability and tight tolerances.

However, there is increasing interest in the application of additive manufacturing as a technology for higher-volume production of identical components and components that need to be used as parts of assemblies. For these applications, larger capacity high-yield systems are frequently required.

Increased capacity is often brought about by increasing the size of the active print area since such increase allows the manufacturing of more components in a single set-up. However, increasing the active print area often results in increased energy deposition artifacts, e.g. image distortion. Such artifacts may reduce the yield through negative impact on compliance with tolerance requirements. This is especially the case when directional radiation sources are used since the output from these sources will often require a very steep—and ideally vertical—entry plane relative to the active print area to avoid distortion. As the area that needs to be covered by a single beam is increased, the angle of entry at the edges of the field becomes progressively flatter, which leads to increased beam distortion.

Multiple solutions have been devised that support the increase of active printing area within a single additive manufacturing apparatus. Patent specification WO2014199149 discloses an apparatus comprising multiple high-energy beams that are operated simultaneously on a workspace to increase the area that is being energized while at the same time minimizing the area that needs to be energized by each individual beam. Patent specification US20130112672 discloses an apparatus comprising a single energy source that is configured to deliver focused energy to multiple locations on a workspace. Also in this case, the objective is to ensure that the area covered by a single beam is minimized. Both documents furthermore cite the use of beam splitters to enable multiple locations on a workspace to be energized by a number of energy sources that is lower than the number of locations to be energized.

Both WO2014199149 and US20130112672 disclose improvements that are well suited for applications involving single free-standing additive manufacturing apparatus. However, situations may arise where it is desirable or necessary to utilize two or more additive manufacturing apparatuses for the manufacture of two or more identical components. This may for instance be the case where a large number of identical components is needed and/or where a large number of geometrically identical components need to be manufactured in more than one material variant. Another situation may be where two or more additive manufacturing processes are carried out with intermediate processing taking place between the additive manufacturing processes and where a first (e.g. building) process may for instance be carried out by a first additive manufacturing apparatus whereas a second (e.g. coating) process may for instance be carried out by a second additive manufacturing apparatus. In such cases (involving at least two additive manufacturing apparatuses), there is a need for reducing yield-reducing variance across the two or more additive manufacturing apparatuses.

In at least some of those cases, it may furthermore be desirable to reduce costs associated with acquiring and operating the two or more additive manufacturing apparatuses. For additive manufacturing apparatuses relying on radiation deposition (such as e.g. UV-based stereolithograpic apparatuses or apparatuses operating lasers), the radiation source is typically one of the most expensive elements. This is especially the case where radiation source quality has to be very high and/or where multiple radiation sources and/or other energy sources need to be combined, as is typically seen in industrial applications. In those and other situations, it is desirable to limit the number of radiation sources required for the operation of the two or more additive manufacturing apparatuses as much as possible.

### SUMMARY OF THE INVENTION

It is an object to alleviate at least one or more of the above mentioned drawbacks at least to an extent.

It is an object to provide manufacturing of multiple identical (at least within practical and/or preferred tolerances) components by two or more additive manufacturing apparatuses that can be carried out with a high and consistent yield and with as little variance as possible and/or as required or preferred. It is another object to provide reduction of the costs of procuring and operating multiple additive manufacturing apparatuses.

Embodiments of the present invention reduce the variability associated with additive manufacturing using multiple additive manufacturing apparatuses. At the same time, costs of acquiring multiple additive manufacturing apparatuses may be reduced.

In a first aspect, the present invention provides an additive manufacturing arrangement, the arrangement comprises at least a first and a second additive manufacturing apparatus, each additive manufacturing apparatus comprising:
a container (also referred to as vat in the following) for holding a radiation-curable liquid,
a build platform having a build surface for holding a product to be manufactured during a manufacturing process, the build platform being movable relative to the container in a predetermined direction,
a local radiation source configured to provide hardening radiation for selectively hardening radiation-curable liquid in the container to form the product,
   and the arrangement is characterized in that it comprises:
a first central radiation source configured to provide hardening radiation for selectively hardening radiation-curable liquid in the first and second container of the respective first and second additive manufacturing apparatus,
each local radiation source comprises a radiation input configured to receive hardening radiation from the first central radiation source and to emit at least part of said hardening radiation to selectively harden radiation-curable liquid in the corresponding container,
a first radiation splitter for splitting radiation from the first central radiation source into at least a first part and a second part,
   wherein the additive manufacturing arrangement is arranged to provide or couple the first part to the radiation input of the first additive manufacturing apparatus and arranged to provide or couple the second part to the radiation input of the second additive manufacturing apparatus.

In some embodiments, the additive manufacturing arrangement further comprises:
a second central radiation source,
a second radiation splitter for splitting radiation from the second central radiation source into a third part and a fourth part,
   wherein the additive manufacturing arrangement is arranged to provide or couple the third part to the radiation input of the first additive manufacturing apparatus and to provide or couple the fourth part to the radiation input of the second additive manufacturing apparatus.

In some embodiments, a peak wavelength of the first central radiation source and a peak wavelength of the second central radiation source are separated by at least 15 nm.

In some embodiments, the first central radiation source and, if present, the second central radiation source, is/are selected from a first group consisting of: a Digital Light Processing (DLP) light source, an LED source; a laser source; a fluorescence radiation source; a filament lamp source.

In some embodiments, the first central radiation source and, if present, the second central radiation source, is/are selected from a second group consisting of: A UVA radiation source; a UVB radiation source; a UVC radiation source; an infrared radiation source; a laser source; an LED source.

In some embodiments, the additive manufacturing arrangement further comprises:
a first radiation meter configured to measure a first radiation intensity of the local radiation source of the first additive manufacturing apparatus,
at least a first feedback circuit configured to receive a first radiation intensity measurement from the first radiation meter and to change a radiation intensity of the central radiation source and/or a radiation intensity of the local radiation source of the first additive manufacturing apparatus based on the first radiation intensity measurement.

Some embodiments further comprise:
a second radiation meter configured to measure a second radiation intensity of the local radiation source radiation of the second additive manufacturing apparatus,
   and wherein the at least a first feedback circuit is further configured to receive a second radiation intensity measurement from the second radiation meter and to control the first and/or the second radiation intensity and/or a radiation intensity of the central radiation source based on the second radiation intensity measurement.

In some embodiments, the first and/or second radiation meter is located near/in vicinity of the respective containers thereby being adapted to measure radiation intensity that actually is provided onto the radiation-curable liquid in each respective manufacturing apparatus

In some embodiments, the at least a first feedback circuit is furthermore configured to reduce a difference between the first radiation intensity and the second radiation intensity. Reducing the difference may e.g. be obtained by adjusting the radiation intensity of the one or more central radiation sources and/or one or more of the local radiation sources.

According to another aspect is provided an additive manufacturing method using an additive manufacturing arrangement in accordance with claims 1-9 (and/or as explained elsewhere in the present description), wherein at least two different materials are used for the additive manufacturing, e.g. at least two different materials used in different additive manufacturing apparatuses (and then e.g. producing a product serially at the different additive manufacturing apparatuses) and/or at least two different materials used in a same additive manufacturing apparatus.

In some embodiments of the method, the at least two materials may differ in their chemical formulation.

In some embodiments of the method, the central radiation source is configured to deliver solidifying radiation, being adapted to the first material, to at least the first additive manufacturing apparatus that is employing said first material for an additive manufacturing process and to deliver solidifying radiation, being adapted to the second material, to at least the second additive manufacturing apparatus that is employing said second material for an additive manufacturing process.

In some embodiments of the method, at least one additively manufactured object or product receives at least a first intermediary processing between a first additive manufacturing process carried out on at least the first additive manufacturing apparatus and the second additive manufacturing process carried out on at least a second additive manufacturing apparatus. In this way, serial production of at least one additively manufactured object or product is provided using two different additive manufacturing apparatuses (with intermediary processing in-between). The first additive manufacturing apparatus may e.g. use a first material while the second additive manufacturing apparatus e.g. uses a second material.

Radiation from the central radiation source(s) may be guided between elements in a number of ways, for instance via optical fibers and/or lens systems.

Embodiments of the invention are applicable to various types of additive manufacturing apparatuses, including bottom-projection and top-projection types.

The invention does not in any way prevent the use of built-in radiation sources from being used in one or more of the additive manufacturing apparatuses.

An advantage of the arrangement and/or the method is that the manufacturing can be more uniform across two or more additive manufacturing apparatuses since the same radiation source is used. If the radiation source degrades, the additive manufacturing apparatuses can be controlled to compensate for the degradation. Different radiation sources of the same type will have different characteristics, even if only slightly. By using a shared radiation source, the effect of such variations is eliminated or at least reduced. Also, by providing measurements from each individual additive manufacturing apparatus, differences arising from the systems used for guiding radiation may be reduced or (essentially) eliminated. Finally, by using a shared radiation source (instead of multiple individual radiation sources), the cost of procuring and operating said radiation source, is distributed across the two or more additive manufacturing apparatuses, which reduces the total costs of ownership compared with additive manufacturing apparatuses running individual radiation sources.

### BRIEF DESCRIPTIONS OF THE DRAWINGS

FIG. 1 illustrates a bottom-projection additive manufacturing apparatus.

FIG. 2 illustrates an embodiment of the invention.

FIGS. 3, 4, 5 and 6 illustrate exemplary embodiments of certain preferred and/or optional elements.

### DETAILED DESCRIPTION OF SELECTED EMBODIMENTS

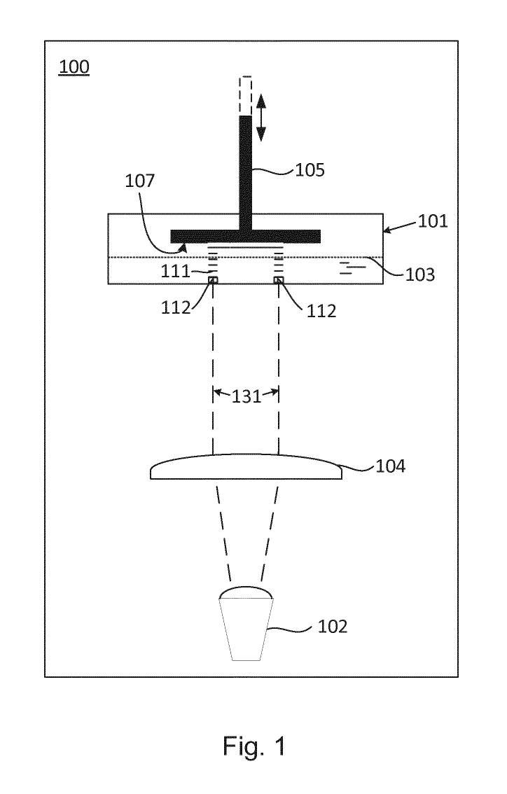

FIG. 1 generically illustrates a bottom-projection type of additive manufacturing apparatus 100. It comprises a vat 101 or other suitable container for holding a radiation-curable liquid 103 (indicated by its surface); a movable platform 105 having a build surface 107 that can be moved relative to the vat e.g. as indicated by the double arrow; and a radiation source 102 for providing hardening radiation 131 for selectively solidifying radiation-curable liquid in the vat. A lens system 104 focuses the radiation onto the radiation-curable liquid. The radiation source can provide radiation in a pattern corresponding to a layer to be formed. Element 111 illustrates already formed layers. Element 112 illustrates a newly formed layer, the shape of which is defined by the pattern provided by the radiation source. The radiation-curable liquid 103 and layers 111 and 112 are not part of the apparatus but are included to illustrate how a product is manufactured during an additive manufacturing process.

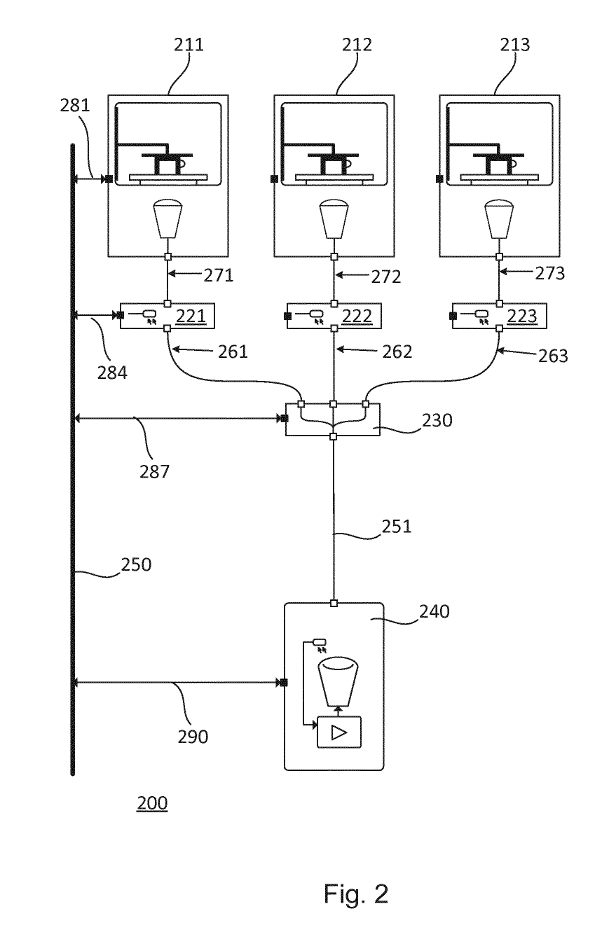

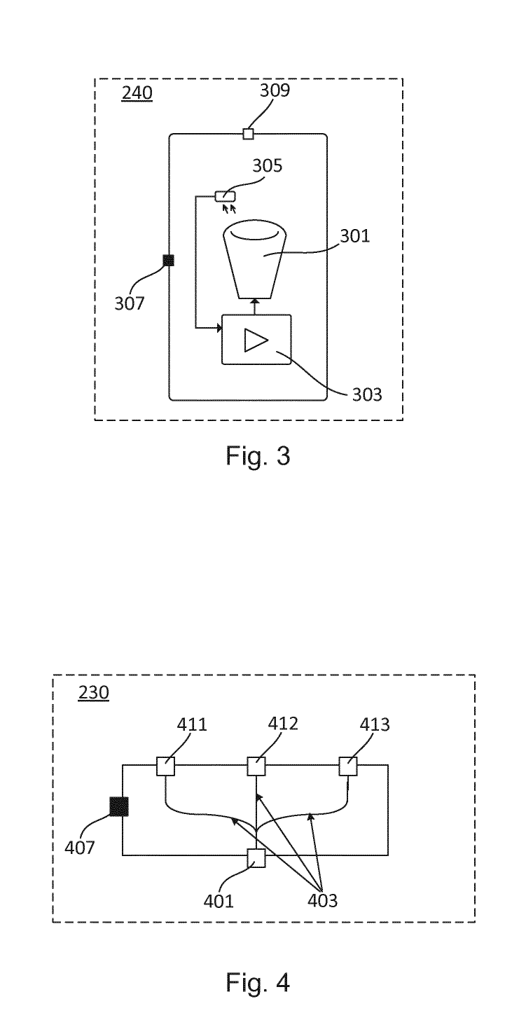

FIG. 2 illustrates an embodiment of the present invention. Shown is an additive manufacturing arrangement 200 comprising a plurality, here three as an example, of additive manufacturing apparatuses 211,212,213 coupled to the same shared central radiation source 240 (e.g. as shown in FIG. 3. A splitter 230 (e.g. as shown in FIG. 4) splits light from the central radiation source into three parts. Each part is guided to a respective one of the manufacturing apparatuses. FIG. 2 illustrates an implementation that employs optical fibers 261,262,263.

Each additive manufacturing apparatus has a radiation input coupled to the optical fibers. Guides 271,272,273 are coupled to respective radiation inputs of the three manufacturing apparatuses.

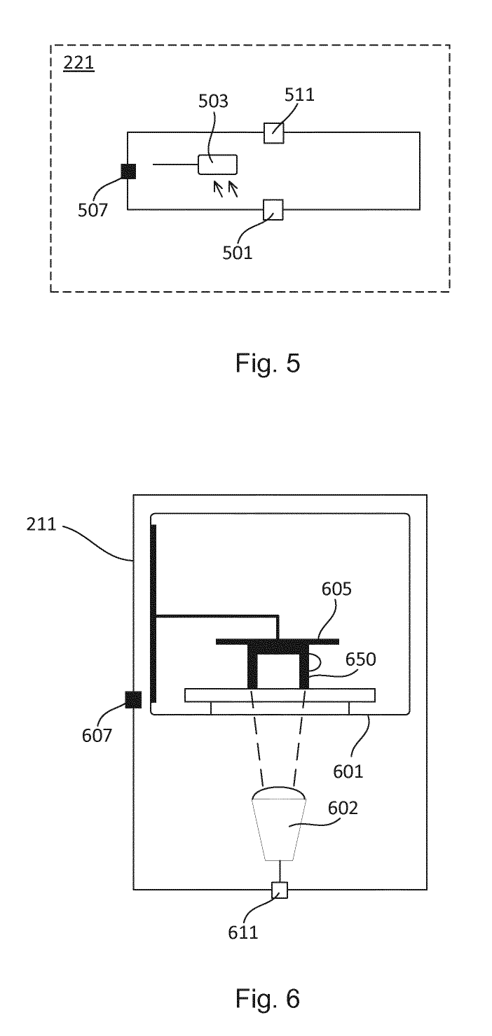

In the present embodiment, three respective radiation meters 221,222,223 (e.g. as shown in FIG. 5) are configured to measure an intensity of radiation being provided to the respective manufacturing apparatuses by the same shared central radiation source via the optical fibers and guides. The radiation meters are illustrated as further being coupled to a central communication bus 250 via a connection 284 (only one connection is shown in the figure for simplicity, but one or more may be connected). The radiation meters can be used to control the intensity at each manufacturing apparatus. Radiation meters may alternatively (or additionally) be located near the vats, whereby they measure the radiation intensity that is actually provided onto the radiation-curable liquid in each manufacturing apparatus. The central communication bus 250 may be a part of the additive manufacturing arrangement 200 (as shown) or alternatively be external to the additive manufacturing arrangement 200.

The additive manufacturing apparatuses, splitter, and the central radiation source are also coupled to the communication bus 250 via connections 281, 287 and 290 to allow exchange of data and/or instructions (only one additive manufacturing apparatus, one splitter and one central radiation source are shown as connected for simplicity, but more additive manufacturing apparatuses and/or splitters and/or central radiation sources may also be connected). They need not all be connected. For instance, the central radiation source might not need to be controllable and thus needs not be connected.

A waveguide 251, such as an optical fiber, guides light from the central radiation source to the splitter.

FIG. 3 illustrates an exemplary embodiment of a central radiation source 240 in more details. This embodiment comprises a radiation provider 301, a driver 303, a bus connector 307 for connecting to a communication bus (e.g. like 250 in FIG. 2), a meter 305, and an output 309. The central light source can be simpler or more complicated depending on specific use.

FIG. 4 illustrates an exemplary embodiment of a splitter 230. It has an input 401 for receiving radiation from the central light source. The splitter splits the radiation into three parts 403 (not necessarily by an equal amount), one part for each additive manufacturing apparatus, and provides them at corresponding outputs 411,412,413. A bus connector 407 allows the splitter to be connected to a communication bus (e.g. like 250 in FIG. 2).

FIG. 5 illustrates an exemplary embodiment of a radiation meter 221 (all radiation meters 221, 222, and 223 of FIG. 2 could and in some embodiments preferably do correspond to this one). It comprises an input 501 for receiving radiation, an output 511 for providing the radiation to a respective additive manufacturing apparatus (e.g. like any one of 211, 212, and 213 in FIG. 2). A radiation meter 503 allows for measurement of the radiation intensity of radiation received by the input 501. A bus connector 507 allows the radiation meter to be connected to a communication bus (e.g. like 250 in FIG. 2). The radiation meter can be used as a verification tool to determine that radiation is present (or not) and in the right (or sufficient) amount (and optionally also wavelength). The measurement of the radiation intensity can be used to either control the radiation source in a respective additive manufacturing apparatus (e.g. like any one of 211, 212, and 213 in FIG. 2) to increase or decrease the intensity. Equalizing the radiation intensity at two or more additive manufacturing apparatuses can be performed using measurements from respective two or more radiation meters and controlling the local radiation sources in the additive manufacturing apparatuses. In at least some embodiments, the radiation meter 221 provides the radiation received at input 501 to output 511 unchanged or substantially unchanged.

FIG. 6 illustrates an exemplary embodiment of a bottom-projection additive manufacturing apparatus 211 (all additive manufacturing apparatuses 211, 212, and 213 of FIG. 2 could, and in some embodiments preferably do, correspond to this one) in more detail. The additive manufacturing apparatus has a build platform 605 configured to move the build platform up during the manufacturing of the product. A manufactured part 650 is illustrated, but is not generally a part of embodiments of the additive manufacturing apparatus. The manufactured part is manufactured by irradiating radiation-curable liquid in the vat 601 with hardening radiation from the local radiation source 602. A bus connector 607 allows the additive manufacturing apparatus to be connected to a communication bus as explained earlier. Radiation from the central light source (or more specifically a part thereof as explained earlier) enters through an input port 611 and is supplied to the local radiation source 602. The local radiation source 602 ‘merely’ function as a transmitter of the radiation received from the central radiation source. The port may be coupled directly to a splitter as explained earlier. In some embodiments, and as described above, a number of components, such as radiation meters are also inserted. Radiation modulators may also be placed between the central radiation source and the additive manufacturing apparatuses. One or more of the additive manufacturing apparatuses may have a local radiation meter that can measure the radiation intensity and/or wavelength near the corresponding vat or vats. At least a first feedback circuit may be used to equalize the radiation intensities at the respective vats. This is particularly useful if identical additive manufacturing apparatuses are used for manufacturing identical products in parallel.

In the following, an additive manufacturing method using an additive manufacturing arrangement as described above and embodiments thereof is described. In some embodiments, at least two different materials (e.g. materials differing in their chemical formulation) are used in the additive manufacturing method.

In some embodiments of the method, the central radiation source is configured to deliver solidifying radiation that is adapted to the first material, to at least the first additive manufacturing apparatus that is employing said first material for an additive manufacturing process and to deliver solidifying radiation that is adapted to the second material, to at least the second additive manufacturing apparatus that is employing said second material for an additive manufacturing process. Adapted to a respective material may for instance comprise being adapted to specific wavelength and/or radiation intensity and/or radiation duration for the respective material.

In some embodiments of the method, at least one additively manufactured object receives at least a first intermediary processing between a first additive manufacturing process carried out on at least the first additive manufacturing apparatus and a second additive manufacturing process carried out on at least a second additive manufacturing apparatus. Said intermediary processing may for instance be one or more instances of one or more of either a cleaning process, a drying process, a curing process, a filling process, a coating and/or surface treatment process, a machining process, a polishing process, an engraving process, a painting process, a corona treatment process, a quality inspection process, or another process that may be required to impart on the object one or more desirable features prior to the second additive manufacturing process.

The scope of the invention is not limited to the embodiments exemplified above but is as defined by the accompanying claims. Embodiments may have fewer or additional elements compared to the examples above. Also, they may be arranged in a different manner. Additional functionality may be included.

A digital processing unit or units may be responsible for controlling the communication bus and for data processing and for sending and/or receiving instructions to and/or one or more of the components of the arrangement.

1. An additive manufacturing arrangement, the arrangement comprising at least a first and a second additive manufacturing apparatus, each additive manufacturing apparatus comprising:
a container for holding a radiation-curable liquid,
a build platform having a build surface for holding a product to be manufactured during a manufacturing process, the build platform being movable relative to the container in a predetermined direction,
a local radiation source configured to provide hardening radiation for selectively hardening radiation-curable liquid in the container to form the product,
the arrangement comprising:
a first central radiation source configured to provide hardening radiation for selectively hardening radiation-curable liquid in the first and second container of the respective first and second additive manufacturing apparatus,
each local radiation source comprises a radiation input configured to receive hardening radiation from the first central radiation source and to emit at least part of said hardening radiation to selectively harden radiation-curable liquid in the corresponding container, and
a first radiation splitter for splitting radiation from the first central radiation source into at least a first part and a second part,
wherein the additive manufacturing arrangement is arranged to provide the first part to the radiation input of the first additive manufacturing apparatus and arranged to provide the second part to the radiation input of the second additive manufacturing apparatus.

2. An additive manufacturing arrangement in accordance with claim 1, further comprising:
a second central radiation source,
a second radiation splitter for splitting radiation from the second central radiation source into a third part and a fourth part,
wherein the additive manufacturing arrangement is arranged to provide the third part to the radiation input of the first additive manufacturing apparatus and to provide the fourth part to the radiation input of the second additive manufacturing apparatus.

3. An additive manufacturing arrangement in accordance with claim 2, wherein a peak wavelength of the first central radiation source and a peak wavelength of the second central radiation source are separated by at least 15 nm.

4. An additive manufacturing arrangement in accordance with claim 1, the first central radiation source and, if present, the second central radiation source being selected from a first group consisting of: a Digital Light Processing (DLP) light source, an light emitting diode (LED) source; a laser source; a fluorescence radiation source; a filament lamp source.

5. An additive manufacturing arrangement in accordance with claim 1, the first central radiation source and, if present, the second central radiation source, being selected from a second group consisting of: AUVA radiation source; a UVB radiation source; a JVC radiation source; an infrared radiation source; a laser source; an LED source.

6. An additive manufacturing arrangement in accordance with claim 1, the additive manufacturing arrangement further comprising:
a first radiation meter configured to measure a first radiation intensity of the local radiation source of the first additive manufacturing apparatus,
at least a first feedback circuit configured to receive a first radiation intensity measurement from the first radiation meter and to change a radiation intensity of the central radiation source and/or a radiation intensity of the local radiation source of the first additive manufacturing apparatus based on the first radiation intensity measurement.

7. An additive manufacturing arrangement in accordance with claim 6, further comprising:
a second radiation meter configured to measure a second radiation intensity of the local radiation source radiation of the second additive manufacturing apparatus,
and wherein the at least a first feedback circuit is further configured to receive a second radiation intensity measurement from the second radiation meter and to control the first and/or the second radiation intensity and/or a radiation intensity of the central radiation source based on the second radiation intensity measurement.

8. An additive manufacturing arrangement in accordance with claim 6, wherein the first and/or second radiation meter is located in vicinity of the respective containers thereby being adapted to measure radiation intensity that actually is provided onto the radiation-curable liquid in each respective manufacturing apparatus.

9. An additive manufacturing arrangement in accordance with claim 7, wherein the at least a first feedback circuit is furthermore configured to reduce a difference between the first radiation intensity and the second radiation intensity.

10. An additive manufacturing method using an additive manufacturing arrangement in accordance with claim 1, characterized in that at least two different materials are used for the additive manufacturing.

11. An additive manufacturing method in accordance with claim 10, wherein the at least two materials may differ in their chemical formulation.

12. An additive manufacturing method in accordance with claim 10, wherein the central radiation source is configured to deliver solidifying radiation, that is adapted to the first material, to at least the first additive manufacturing apparatus that is employing said first material for an additive manufacturing process and to deliver solidifying radiation, that is adapted to the second material, to at least the second additive manufacturing apparatus that is employing said second material for an additive manufacturing process.

13. An additive manufacturing method using an additive manufacturing arrangement in accordance with claim 10, wherein at least one additively manufactured object receives at least a first intermediary processing between a first additive manufacturing process carried out on at least the first additive manufacturing apparatus and a second additive manufacturing process carried out on at least a second additive manufacturing apparatus.

14. An additive manufacturing arrangement in accordance with claim 2, the additive manufacturing arrangement further comprising:
a first radiation meter configured to measure a first radiation intensity of the local radiation source of the first additive manufacturing apparatus,
at least a first feedback circuit configured to receive a first radiation intensity measurement from the first radiation meter and to change a radiation intensity of the central radiation source and/or a radiation intensity of the local radiation source of the first additive manufacturing apparatus based on the first radiation intensity measurement.

15. An additive manufacturing arrangement in accordance with claim 14, wherein a peak wavelength of the first central radiation source and a peak wavelength of the second central radiation source are separated by at least 15 nm.

16. An additive manufacturing arrangement in accordance with claim 7, wherein the first and/or second radiation meter is located in vicinity of the respective containers thereby being adapted to measure radiation intensity that actually is provided onto the radiation-curable liquid in each respective manufacturing apparatus.

17. An additive manufacturing arrangement in accordance with claim 16, wherein the at least a first feedback circuit is furthermore configured to reduce a difference between the first radiation intensity and the second radiation intensity.

18. An additive manufacturing method in accordance with claim 11, wherein the central radiation source is configured to deliver solidifying radiation, that is adapted to the first material, to at least the first additive manufacturing apparatus that is employing said first material for an additive manufacturing process and to deliver solidifying radiation, that is adapted to the second material, to at least the second additive manufacturing apparatus that is employing said second material for an additive manufacturing process.

19. An additive manufacturing method using an additive manufacturing arrangement in accordance with claim 11, wherein at least one additively manufactured object receives at least a first intermediary processing between a first additive manufacturing process carried out on at least the first additive manufacturing apparatus and a second additive manufacturing process carried out on at least a second additive manufacturing apparatus.

20. An additive manufacturing method using an additive manufacturing arrangement in accordance with claim 12, wherein at least one additively manufactured object receives at least a first intermediary processing between a first additive manufacturing process carried out on at least the first additive manufacturing apparatus and a second additive manufacturing process carried out on at least a second additive manufacturing apparatus.
